(19) United States
(12) Patent Application Publication
(10) Pub. No.: US 2005/0172675 A1
(43) Pub. Date: Aug. 11, 2005

(54) Method of and apparatus for manufacturing single mode optical fiber

(75) Inventor: Fumio Takahashi, Chiyoda-ku (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: The Furukawa Electric Co., Ltd., Chiyoda-ku (JP)

(21) Appl. No.: 10/775,096

(22) Filed: Feb. 11, 2004

(51) Int. Cl. C03B 37/075

(52) U.S. Cl. 65/402; 65/504

(57) ABSTRACT

A method of manufacturing an optical fiber includes heating at least a portion of an optical fiber preform, drawing an optical fiber at a speed of 500 m/min from the optical fiber preform heated, and impressing a spin on the optical fiber, while drawing, alternately in a clockwise and in a counterclockwise direction with a predetermined angle. Maximum spatial frequency of the spin per meter y satisfies exp(24x−12)≦y≦4 where x is non-circularity of the cladding in percent. The optical fiber has a relative refractive index difference of 0.3% to 0.5%, and a mode field diameter of 8 μm to 10 μm at a wavelength of 1310 nm, A polarization mode dispersion of the optical fiber manufactured is 0.5 ps/km^{1/2} or less at the wavelength of 1310 nm.

### BACKGROUND OF THE INVENTION

1) Field of the Invention

The present invention relates to a method of and an apparatus for manufacturing a single mode optical fiber used in a wavelength division multiplexing (WDM) system.

2) Description of the Related Art

One of the technologies to increase transmission capacity in optical fiber communications is the WDM system; and optical fibers suitable for the WDM system are being developed.

The WDM system requires the optical fiber having low polarization mode dispersion (PMD) of preferably 0.5 ps/km^{1/2} or less.

U.S. Pat. No. 5,298,047 discloses a technology of impressing a spin on the optical fiber alternately in clockwise and counterclockwise directions during drawing from an optical fiber preform. This technology particularly specifies that the optical fiber should be impressed a spin whose spatial frequency is preferably more than four times per meter.

However, as the spatial frequency of the spin of the optical fiber increases, micro defects tend to be introduced in the optical fiber, and balance of the spin between the clockwise direction and the counterclockwise direction. As a result, a residual spin is formed in the optical fiber. Since the optical fiber with such micro defects or residual spin is unusable, utmost care should be paid to avoid the micro defects or residual spin.

Moreover, if the spatial frequency of the spin per meter of the optical fiber is large, the fluctuation in the outer diameter of the optical fiber at high drawing speeds is likely to be large. Specifically, the fluctuation in the outer diameter of the optical fiber will be large when the optical fiber is impressed a spin of more than five times per meter at a high drawing speed of 500 meters per minute or more.

Japanese Patent Laid-Open Publication No. H7-69665 discloses a technology for reducing the PMD of an optical fiber with a non-circular core. However, the disclosed optical fiber is impressed a spin uniformly only in one direction. This type of optical fiber cannot suppress the PMD sufficiently.

### SUMMARY OF THE INVENTION

It is an object of the present invention to solve at least the problems described above.

A method of manufacturing an optical fiber according to one aspect of the present invention includes heating at least a portion of an optical fiber preform, drawing an optical fiber at a speed of 500 meters per minutes or more from the optical fiber preform heated, and impressing a spin on the optical fiber, while drawing, alternately in a clockwise direction and in a counterclockwise direction with a predetermined angle. Maximum spatial frequency “y” of the spin per meter satisfies a relationship of exp(24x−12)≦y≦4 where “x” is non-circularity of the cladding in percent. The optical fiber includes a core and a cladding and having a maximum relative refractive index difference of the core with the cladding of 0.3% to 0.5% and a mode field diameter of 8 micrometers to 10 micrometers at a wavelength of 1310 nanometers. A polarization mode dispersion of the optical fiber manufactured is 0.5 ps/km^{1/2} or less at a wavelength of 1310 nm.

An apparatus for manufacturing an optical fiber, according to another aspect of the present invention includes a drawing capstan that draws the optical fiber at a speed of 500 meters per minutes, and a plurality of guide rollers that guides the optical fiber being drawn with one of the guide rollers oscillating at a predetermined speed with a predetermined angle to impress a spin on the optical fiber, while drawing, alternately in a clockwise direction and in a counterclockwise direction. Maximum spatial frequency of the spin per meter “y” satisfies a relationship of exp(24x−12)≦y≦4 where “x” is non-circularity of the cladding in percent. The optical fiber includes a core and a cladding and having a maximum relative refractive index difference of the core with the cladding of 0.3% to 0.5% and a mode field diameter of 8 micrometers to 10 micrometers at a wavelength of 1310 nanometers. A polarization mode dispersion of the optical fiber manufactured is 0.5 ps/km^{1/2} or less at a wavelength of 1310 nm.

The other objects, features, and advantages of the present invention are specifically set forth in or will become apparent from the following detailed descriptions of the invention when read in conjunction with the accompanying drawings.

### BRIEF DESCRIPTION OF THE DRAWINGS

FIG. 1 is a cross-section of a single mode optical fiber fabricated by a method according to the present invention, and an example of a refractive index profile of the fiber; and

FIG. 2 is a top plan view of a portion of an apparatus that impresses a spin on the optical fiber while drawing.

### DETAILED DESCRIPTION

Exemplary embodiments of a method of manufacturing a single mode optical fiber according to the present invention are explained in detail with reference to the accompanying drawings.

According to the conventional technology, since the optical fiber should be impressed a spin more than five times per meter to suppress the PMD of the optical fiber, which has a complicated refractive index profile with a maximum relative refractive index difference of the core with the cladding Δ of more than 0.5%, to 0.5 ps/km^{1/2} or less, it is not easy to realize a drawing speed of 500 meters per minute or more. However, the inventors discovered that it is possible to draw the optical fiber at a speed of more than 500 meters per minute while suppressing the PMD to 0.5 ps/km^{1/2} or less in an optical fiber that has a simple step index profile with the maximum relative refractive index difference of the core with the cladding Δ of 0.5% or less, even if the optical fiber is impressed a spin not more than four times per meter, by controlling non-circularity of the cladding together.

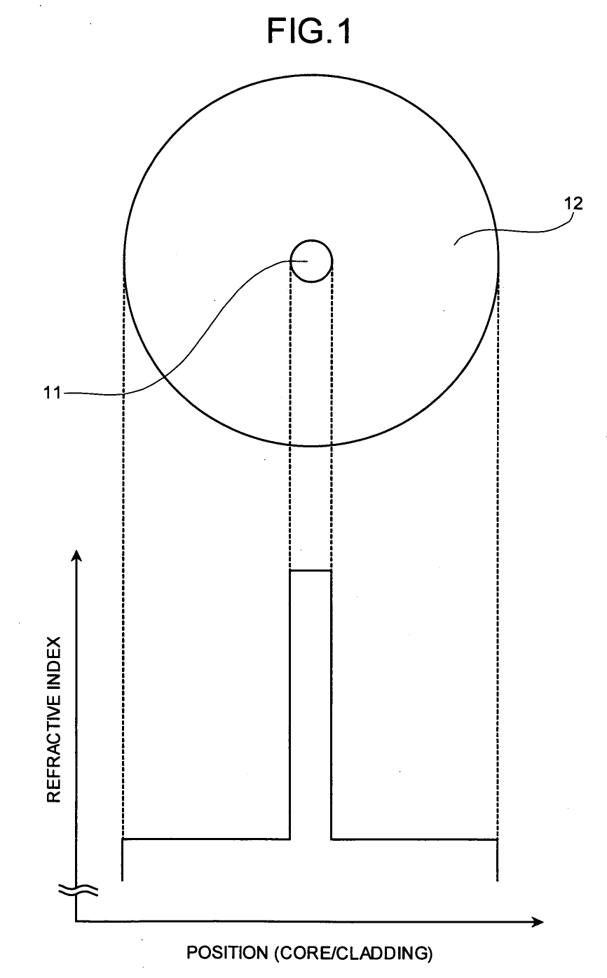

FIG. 1 is a cross-section of a single mode optical fiber manufactured by a method according to the present invention, and an example of a refractive index profile of the fiber. The fiber includes a core 11 and a cladding 12. The maximum relative refractive index difference of the core with the cladding Δ is 0.3% to 0.5%. The mode field diameter at a wavelength of 1310 nm is 8 μm to 10 μm. The outer diameters of the cladding 12 is around 125 μm, 125±2 μm.

The single mode optical fiber may also have a circular region with somewhat higher refractive index or a somewhat lower refractive index than that of the cladding 12 between the core 11 and the cladding 12. Even in this case, the maximum relative refractive index difference of the core with the cladding Δ is 0.3% to 0.5%, and the mode field diameter at a wavelength of 1310 nm is 8 μm to 10 μm.

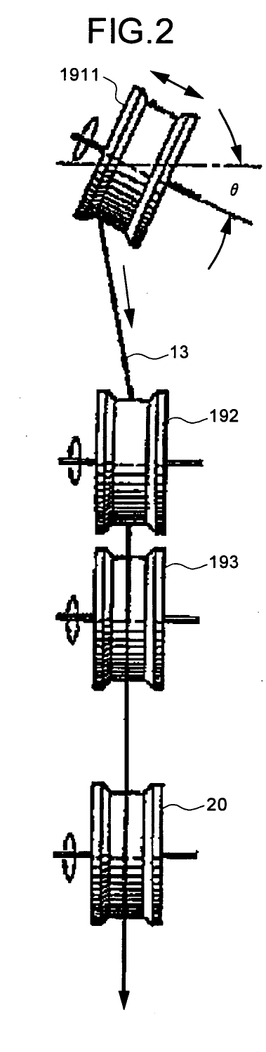

FIG. 2 is a top view of a guide portion of an apparatus that applies spin on the optical fiber while drawing. The figure is shown in the U.S. Pat. No. 5,298,047. The reference numeral 13 indicates an optical fiber. The reference numerals 1911, 192, and 193 indicate guide rollers. The reference numeral 20 indicates a drawing capstan. The optical fiber 13 has the refractive index profile shown in FIG. 1 and has a coating layer. The guide roller 1911 oscillates at an angle θ.

The method according to the present embodiment differs from the conventional art in that the spin condition of the optical fiber is determined to satisfy a relationship of
exp(24x−12)≦y≦4
where “x” is the non-circularity of the cladding, and “y” is a maximum spatial frequency of the spin per meter. By setting the above spin condition, a PMD of 5 ps/km^{1/2} or less can be realized and the fluctuation in the outer diameter can be considerably reduced even at a high speed drawing of 500 meters or more.

When the non-circularity of the cladding is 0.2% or less, the required maximum spatial frequency of the spin per meter drops to 0.001. This means that the PMD can be reduced to 0.5 ps/km^{1/2} or less practically without any spin. It is essential to maintain the non-circularity of the cladding to 0.5% or less since the non-circularity of the cladding of 0.56% results in exp(24x−12)>4.

The spin condition for obtaining a PMD of 0.5 ps/km^{1/2} or less was studied for the optical fiber drawn at a speed of 1000 meters per minute. The result of the study is given in Table 1. The symbol O in the column ‘PMD’ indicates a value of 0.5 ps/km^{1/2} or less. The symbol O in the column fluctuation in outer diameter indicates that an outer diameter of an optical fiber is within 125 μm±μm.

TABLE 1

| | | maximum | | |
|---|---|---|---|---|
| | non-circularity | spatial | | fluctuation in |
| | of the cladding | frequency | | outer |
| | “x” | of spin “y” | PMD | diameter |
| example 1 | 0.30 | 0.01 | ◯ | ◯ |
| example 2 | 0.40 | 0.15 | ◯ | ◯ |
| example 3 | 0.50 | 1.50 | ◯ | ◯ |
| example 4 | 0.55 | 3.50 | ◯ | ◯ |
| comparison 1 | 0.35 | 0.02 | X | ◯ |
| comparison 2 | 0.45 | 0.25 | X | ◯ |
| comparison 3 | 0.60 | 4.00 | X | ◯ |
| comparison 4 | 0.60 | 12.00 | ◯ | X |

The PMDs in the example 1 to the example 4, which satisfy the relationship of exp(24x−12)≦y≦4, are 0.5 ps/km^{1/2} or less, and there is practically no fluctuation in the outer diameter of the fiber.

On the other hand, the PMDs in the comparison 1 to the comparison 4, which do not satisfy the relationship of exp (24x−12)≦y, exceed 0.5 ps/km^{1/2} and are not for practical use. In the comparison 4, the relationship of exp (24y−12)≦y is satisfied, but, y≦4 is not satisfied. Therefore, in this case a fluctuation in the outer diameter becomes large.

It was also verified that, even when the fiber is drawn at a speed of up to 2000 meters per minute, the PMD is well suppressed to 0.5 ps/km^{1/2} or less as long as the relationship of exp (24x−12)≦y≦4 is satisfied, and the fluctuation in the outer diameter is kept within a tolerance limit.

It is well known that the non-circularity of the core is closely related with the PMD, however, from the dedicated study conducted as described above, it is found that the non-circularity of the cladding is also closely related with the PMD. As a result, if the maximum spatial frequency of the spin is determined as described above, the PMD of the optical fiber can be suppressed to 0.5 ps/km^{1/2} or less, and the fluctuation in the outer diameter of a single mode optical fiber, which has a maximum relative refractive index difference of the core with the cladding of 0.3% to 0.5% and whose mode field diameter is 8 μm to 10 μm at a wavelength of 1310 nm, can be reduced sufficiently even if it is drawn at a speed of 500 meters per minute or more.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

1. A method of manufacturing an optical fiber, the optical fiber comprising a core and a cladding and having a maximum relative refractive index difference of the core with the cladding of 0.3% to 0.5% and a mode field diameter of 8 micrometers to 10 micrometers at a wavelength of 1310 nanometers, comprising:
heating at least a portion of an optical fiber preform;
drawing an optical fiber at a speed of 500 meters per minute or more from the optical fiber preform heated; and
impressing a spin on the optical fiber, while drawing, alternately in a clockwise direction and in a counterclockwise direction with a predetermined angle in such a manner that a maximum spatial frequency “y” of the spin per meter satisfies a relationship of
exp(24x−12)≦y≦4
where “x” is non-circularity of the cladding in percent, and that a polarization mode dispersion of the optical fiber manufactured is 0.5 ps/km^{1/2} or less at the wavelength of 1310 nanometers.

2. An apparatus for manufacturing an optical fiber, the optical fiber comprising a core and a cladding and having a maximum relative refractive index difference of the core with the cladding of 0.3% to 0.5% and a mode field diameter of 8 micrometers to 10 micrometers at a wavelength of 1310 nanometers, comprising:
a drawing capstan that draws the optical fiber at a speed of 500 meters per minute or more; and
a plurality of guide rollers that guides the optical fiber being drawn, wherein
one of the guide rollers oscillates at a predetermined speed with a predetermined angle to impress a spin on the optical fiber, while drawing, alternately in a clockwise direction and in a counterclockwise direction, in such a manner that a maximum spatial frequency “y” of the spin per meter y satisfies a relationship of
exp(24x−12)≦y≦4
where “x” is non-circularity of the cladding in percent, and that a polarization mode dispersion of the optical fiber manufactured is 0.5 ps/km^{1/2} or less at the wavelength of 1310 nanometers.
